(19) United States
(12) Patent Application Publication
(10) Pub. No.: US 2010/0103149 A1
(43) Pub. Date: Apr. 29, 2010

(54) Driving System of Liquid Crystal Display

(75) Inventor: WEN TSUNG LIN, Tainan County (TW)

Correspondence Address: HDLS IPR Services, PO Box 220746, Chantilly, VA, 20153, US

(73) Assignee: Chi Mei Optoelectronics Corp.

(21) Appl. No.: 12/647,891

(22) Filed: Dec. 28, 2009

Related U.S. Application Data
(62) Division of application No. 11/254,910, filed on Oct. 21, 2005, now abandoned.

(30) Foreign Application Priority Data
Mar. 11, 2004 (TW) 94107528

(51) Int. Cl. G09G 5/00

(52) U.S. Cl. 345/204; 345/99

(57) ABSTRACT

A driving system of a liquid crystal display includes a pixel data line, a timing controller, a source driver and a gate driver. The pixel data line provides pixel data to the source driver directly. The timing controller is operative to receive a clock signal and a synchronization signal, so as to output a source control signal and a gate control signal. The source driver receives the clock signal, the source control signal and the pixel data, so as to output an image data signal. Upon receiving the gate control signal, the gate driver is operative to output an on/off signal.

This application is a divisional application of U.S. patent application Ser. No. 11/254,910, filed on Oct. 21, 2005.

### BACKGROUND OF THE INVENTION

1. Field of Invention

The present invention relates in general to a driving system, and more particularly, to a driving system applied to a liquid crystal display.

2. Related Art

Among various flat-panel display techniques that have been developed in recent years, liquid crystal displays have been broadly applied in various consuming electronic or computer products such as medium or small size portable television, cell phone, camcorder, laptop computer, desktop display, and projection television for having the advantages of high picture quality, small size, light weight, low driving voltage, low power consumption and broad applications. Currently, the conventional cathode ray tube display products have been replaced by the liquid crystal displays, particularly the thin-film transistor liquid crystals.

In a liquid crystal display, the gate driver is used to transmit on or off signal to the transistor of the display. Therefore, the gate driver is often referred as scan driver. The source driver is responsible for converting the digital signal into analog voltage value, so as to transmit image signal to the display. Therefore, the source driver is also referred as data driver. The scan line is responsible to control the switching transistor according to an activation pulse period. When the switching transistor is on, the data line is operative to input the pixel data to the liquid crystal unit through the switching transistor. The liquid crystal display further comprises a timing controller operative to generate the control signals for the gate driver and the source driver, through which the electronic signals of image can be transmitted to the display.

Referring to FIG. 1, the conventional driving system of a liquid crystal display includes a timing controller 108, a source driver 110 and a gate driver 112. The timing controller 108 is mounted on a control board 102. The source driver 110 is carried by a tape carrier package (TCP) or chip on film (COF) 114 and electrically connected to a signal line on an X board 104 and a power source using anisotropic conductive film (ACF). The gate driver 112 is carried by the tape carrier package 114 and electrically connected to a signal line on a Y board 106 and the power source using anisotropic conductive film. The X board 104 and the Y board 106 are used for processing electrical signals. In addition, a flexible printed circuit board 116 is used to connect the control board 102 to the X board 104 and the control board 102 to Y board 106.

In the conventional driving system of thin-film transistor liquid crystal display, the timing controller 108 is operative to receive a clock signal 118, a synchronization signal 120, and a pixel data 122 , and then to generate a gate control signal 124, data 126 provided to the source driver 110 and a source control signal 128 according to the synchronization signal 120 and the pixel data 122. The data 126 and the pixel data 122 are substantially the same. However, the input of the pixel data 122 and the output of the data 126 that occupy most of the pins of the timing controller 108 have become a major obstacle for reducing cost.

### SUMMARY OF THE INVENTION

A driving system of a liquid crystal display is provided to reduce the required number of pins of the timing controller, so as to reduce the size of the control board, or even eliminate the usage of the control board, such that the cost is greatly reduced.

A driving system of a liquid crystal display is provided to integrate the source driver with the timing controller to greatly lower the complexity of the driving system.

The driving system as provided can also reduce the usage of the printed circuit board (PCB) and the wirings, so that the cost is further lowered.

In one aspect, the driving circuit of the present invention comprises a timing controller, a source driver, a gate driver and a pixel data line. The timing controller receives a clock signal and a synchronization signal and outputs a source control signal and a gate control signal. The source driver is electrically connected to the timing controller for receiving the clock signal, the source control signal and the pixel data directly so as to output an image data signal. The gate driver is electrically connected to the timing controller for receiving the gate control signal so as to output an on/off signal.

Either the source driver or the gate driver can be carried by a tape carrier package or a glass substrate package.

In another aspect, the driving circuit of the present invention comprises a pixel data line, an integrated source driver and a gate driver. The pixel data line provides a pixel data. The integrated source driver includes a timing controller and a source driver. The timing controller receives a clock signal and a synchronization signal and outputs a source control signal and a gate control signal. The source driver receives the clock signal, the source control signal and the pixel data directly so as to output an image data signal. The gate driver receives the gate control signal so as to output an on/off signal.

The integrated source driver is carried by a tape carrier package or a glass substrate package. The driving circuit further comprises an indication signal line connected to the integrated source driver to indicate the status of the source driver.

In still another aspect, the driving circuit of the present invention comprises a pixel data line, a source driver and an integrated gate driver. The pixel data line provides a pixel data. The integrated gate driver includes a timing controller and a gate driver. The timing controller receives a clock signal and a synchronization signal and outputs a source control signal and a gate control signal. The gate driver receives the gate control signal to output an on/off signal. The source driver receives the clock signal, the source control signal and the pixel data directly to output an image data signal.

The integrated gate driver is carried by a tape carrier package or a glass substrate package. The driving circuit further comprises an indication signal line connected to the integrated gate driver to indicate the status of the gate driver.

### BRIEF DESCRIPTION OF THE DRAWINGS

The present invention will become more fully understood from the detailed description given hereinbelow illustration only, and thus are not limitative of the present invention, and wherein:

FIG. 1 is a schematic drawing of a conventional driving system for a thin-film transistor liquid crystal display;

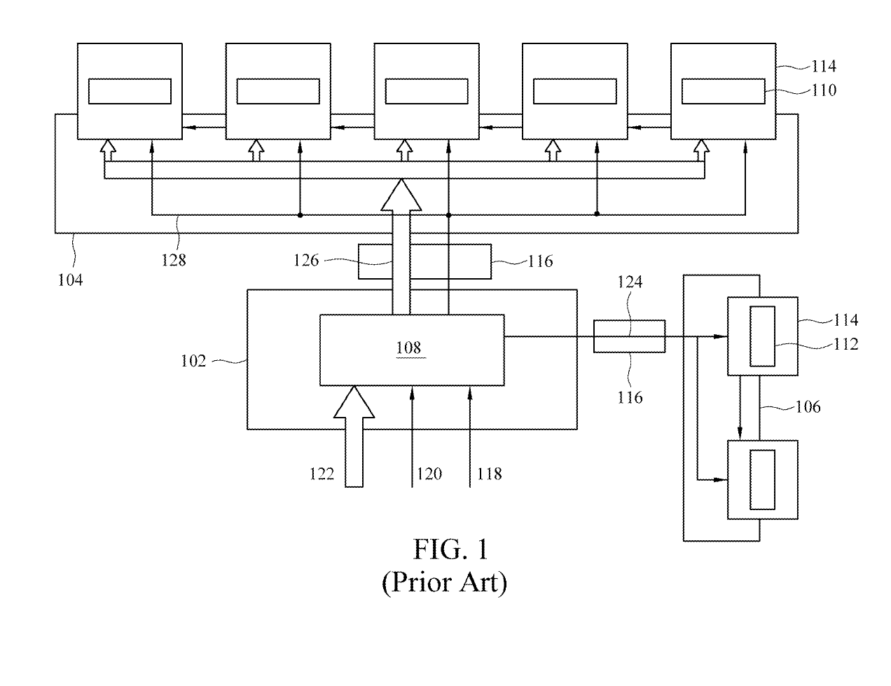

FIG. 2 shows a driving system of a liquid crystal display in one embodiment of the present invention;

FIG. 3 shows another embodiment of the driving circuit; and

FIG. 4 shows yet another embodiment of the driving circuit.

### DETAILED DESCRIPTION OF THE INVENTION

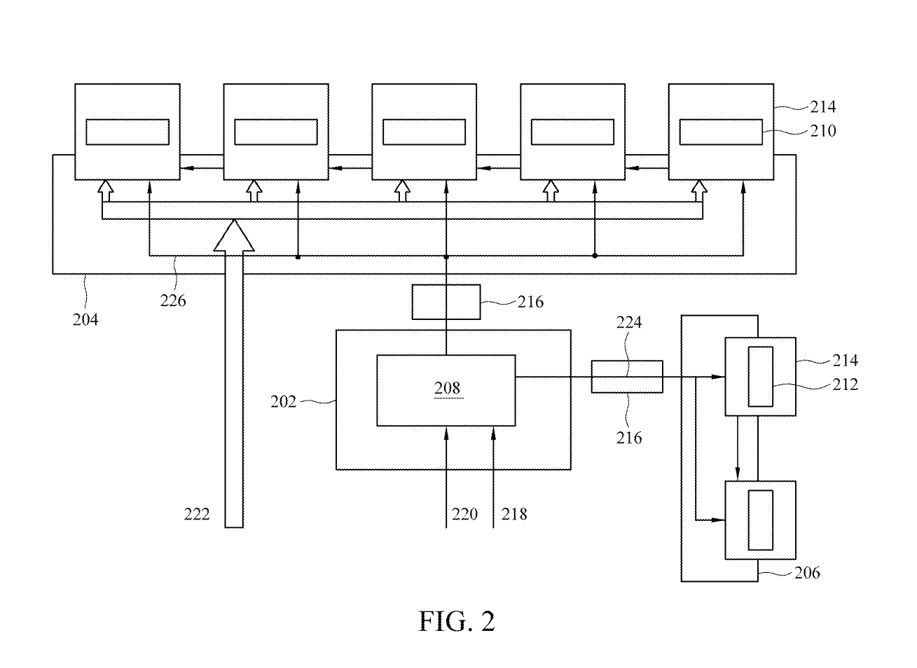

Referring to FIG. 2, the driving system as provided comprises at least a source driver 210, a gate driver 212, and a timing controller 208. The timing controller 208 is mounted on a control board 202. Compared to the conventional timing controller, the timing controller 208 has much less pins and smaller volume. The source driver 210 is connected to an X board 204, and the gate driver 212 is connected to a Y board 206. The X board 204 and the Y board 206 are responsible for processing electric signal. The source driver 210 and the gate driver 212 are carried by a tape carrier 214 or a glass substrate. The above tape carrier 214 includes a tape carrier package or a film package. In addition, a flexible printed circuit board 216 is used to connect the control board 202 to the X board 204 and the control board 202 to the Y board 206.

The operation of the driving system is illustrated in FIG. 2. The clock signal 218 and the synchronization signal 220 are input to the timing controller 208, and the gate control signal 224 and the source control signal 226 are then output by the timing controller 208. The pixel data 222 are directly input to the source driver 210 without passing through the timing controller 208. In this embodiment, as the pixel data 222 is not transmitted through the timing controller 208, the pin number of the timing controller 208 can be reduced. The sizes of the timing controller 208 and the control board 202 are thus reduced. In addition, the wiring between the control board 202 and the source driver 210 is only responsible to transmit the source control signal 226. Therefore, such type of connection can simplify the wiring between the control board 202 and the source driver 210 on X board 204.

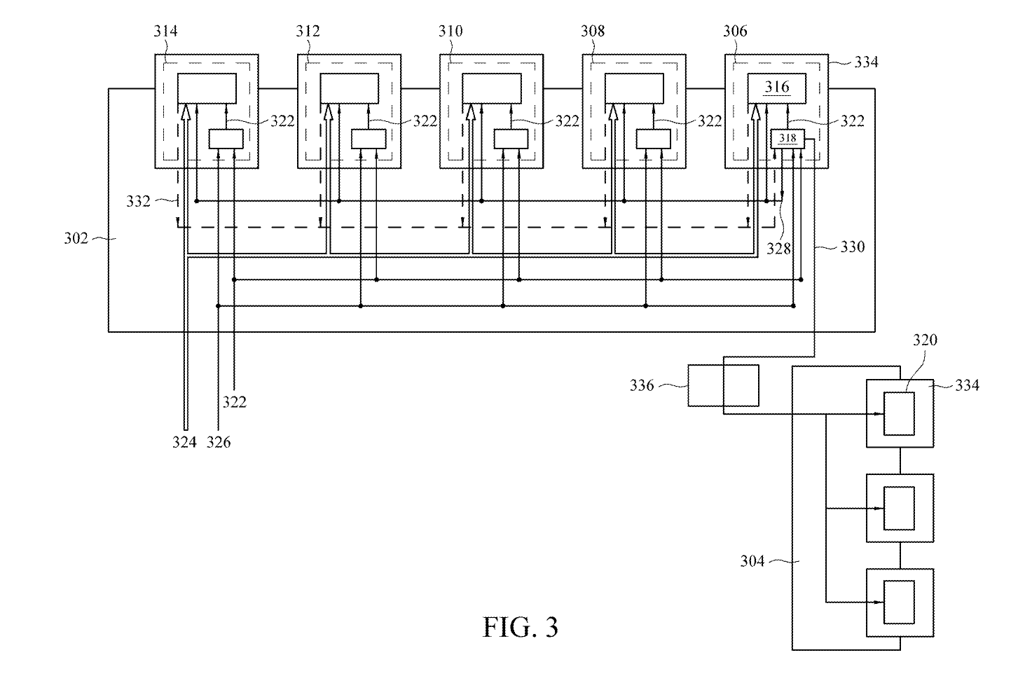

As shown in FIG. 3, the driving system includes at least an integrated source driver 306 and a gate driver 320. The integrated source driver 306 is connected to the X board 302, while the gate driver 320 is connected to a Y board 304. The integrated source driver 306 includes a source driver 316 integrated with a timing controller 318. In this embodiment, the pixel data 324 is directly input to the source driver integrated in each integrated source driver (such as the integrated source drivers 306, 308, 310, 312, and 314), while the clock signal 322 and the synchronization signal 326 are input to the timing controller in each integrated source driver. A source control signal 328 and a gate control signal 330 are then output from the timing controller of any of the integrated source driver (such as the timing controller 318) to each source driver and each gate driver separately, such that the source drivers and the gate drivers can output the image data signal and the on/off signal, respectively.

In addition, to further simplify and reduce the size of the integrated source driver, each integrated source driver is operative to connect an indication signal 332 to the timing controller 318 for indicating the state of each integrated source driver as the reference for the timing controller 318.

As the integrated source drivers 306, 308, 310, 312 and 314 are substantially the same, the timing controller of any of them can be selected and used to provide the control signal. For example, the integrated source driver 306 is selected to provide the source control signal 328 and the gate control signal 330 by the timing controller 318. A plurality of integrated source drivers can also be selectively used. For example, the integrated source drivers 306, 310 and 312 can all be selected and used.

In this embodiment, as the timing controller has been integrated with the source driver, the wiring connection is simplified and the control board is not required. The volume increased by integrating the timing controller is insignificant compared to the original source driver. In addition, the integrated source driver can be carried by tape carrier package or glass substrate package.

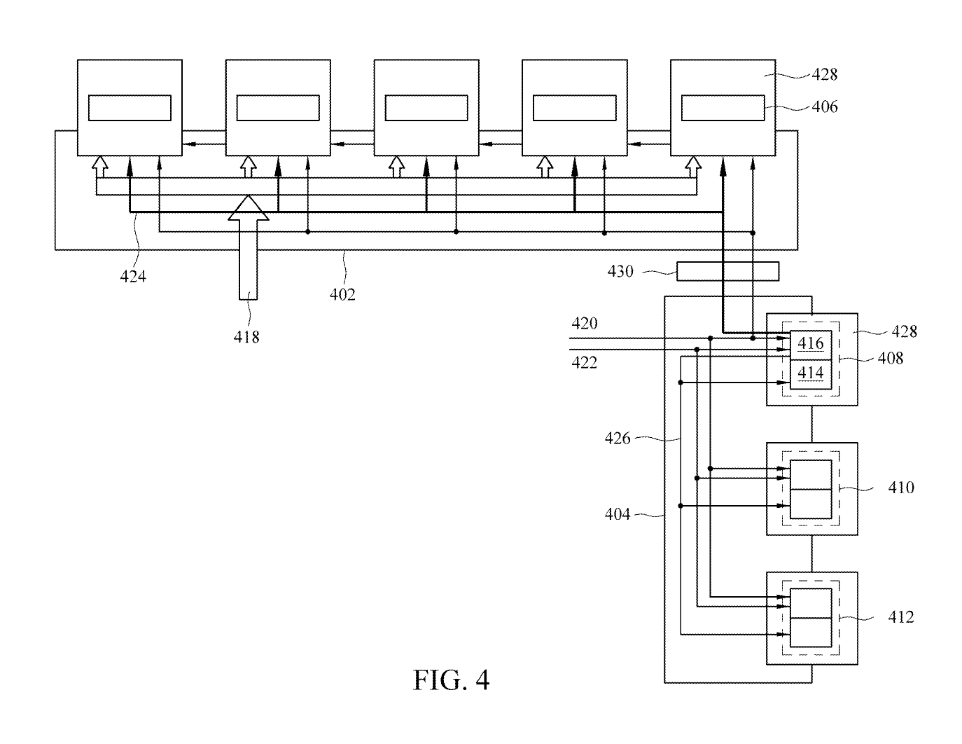

Referring to FIG. 4, another embodiment of a driving system is illustrated. As shown, the driving system includes at least a source driver 406 and an integrated gate driver 408. The source driver 406 is connected to an X board 402, and the integrated gate driver 408 is connected to a Y board 404. The integrated gate controller 408 is formed by integrating a gate driver 414 and a timing controller 416. In this embodiment, the pixel data 418 is directly input to each source driver, and the clock signal 420 is input to each source driver and each integrated gate driver, while the synchronization signal 422 is input to the timing controller of each integrated gate controller, followed by a source control signal 424 and a gate control signal 426 output from the timing controller of any of the integrated gate driver (such as the timing controller 416 as shown in FIG. 4) to each source driver and each integrated gate driver separately, such that the source driver and the gate driver can output the image data signal and the on/off signal, respectively.

Similarly, as the integrated gate drivers 408, 410 and 412 are the same from each other, at least one of them can be selected to provide the required control signal from the timing controller thereof. On the other hand, the integrated gate drivers can also be carried by tape carrier package or glass substrate package. In the embodiment, an indication signal line (not shown) can also be used to connect the integrated gate driver to indicate the state of each integrated gate driver.

According to the above-mentioned description, the present invention has advantages as follows. The driving system of the liquid crystal display can reduce the required number of pins of the timing controller, so as to reduce the size of the control board, simplify the wiring connection, or even eliminate the usage of the control board, such that the cost is greatly reduced. Moreover, the driving system of a liquid crystal display can integrate the source or gate driver with the timing controller to greatly lower the complexity of the driving system.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A driving system of a liquid crystal display, comprising:
a pixel data line to provide a pixel data;
a first integrated source driver including:
a first timing controller for receiving a clock signal and a synchronization signal and outputting a source control signal and a gate control signal; and
a first source driver for receiving the clock signal, the source control signal and the pixel data so as to output a first image data signal; and
a second integrated source driver including:
a second timing controller for receiving the clock signal and the synchronization signal; and
a second source driver for receiving the clock signal, the source control signal and the pixel data so as to output a second image data signal; and
a gate driver for receiving the gate control signal so as to output an on/off signal.

2. The driving system of claim 1, wherein the integrated source driver is carried by a tape carrier package or a glass substrate package.

3. The driving system of claim 1, further comprising an indication signal line connected to the integrated source driver to indicate the status of the source driver.
